(19) United States
(12) Patent Application Publication
(10) Pub. No.: US 2018/0286006 A1
(43) Pub. Date: Oct. 4, 2018

(54) TILE REUSE IN IMAGING

(71) Applicant: INTEL CORPORATION, Santa Clara, CA (US)

(72) Inventors: Nikos Kaburlasos, Lincoln, CA (US); Kinchit Desai, Folsom, CA (US); Sanjeev S. Jahagirdar, Folsom, CA (US)

(73) Assignee: INTEL CORPORATION, Santa Clara, CA (US)

(21) Appl. No.: 15/477,249

(22) Filed: Apr. 3, 2017

(51) Int. Cl. G06T 1/20; G06T 1/60

(52) U.S. Cl. CPC G06T 1/20; G06T 1/60

(57) ABSTRACT

An apparatus for tile reuse in imaging is described herein. The apparatus a memory, a line based processing system, a block based processing system, and a tile reuse indicator. The memory is to store imaging data. The line-based processing system is to process lines of imaging data and store the processed data in memory and the block-based processing system is to process blocks of the line based processed imaging data and storing the processed data in memory. The tile reuse indicator is to determine an unchanged tile of the imaging data, and in response to an unchanged tile prevent further processing of the unchanged tile.

### BACKGROUND ART

During image processing, raw image data may be obtained from a camera via a plurality of pixels. The pixels may be first stored in a line-by-line pattern in memory. Each line may be referred to as a scan line, and the ordering of the pixels may be referred to as raster order. Further image processing may be performed in a block-by-block fashion. During a video sequence that comprises a plurality of frames, portions of both the lines and blocks may be unchanged, such as during surveillance or video chat applications.

### BRIEF DESCRIPTION OF THE DRAWINGS

FIG. 1 is a block diagram of a computing device configured for tile reuse during imaging;

FIG. 2 is an image processing (IPU) system;

FIG. 3 is an illustration of memory partitions;

FIG. 4 is a process flow diagram of a method for tile reuse;

FIG. 5 is a process flow diagram of a method for tile reuse in imaging; and

FIG. 6 is a block diagram showing tangible, non-transitory computer-readable media that stores code for tile reuse in imaging.

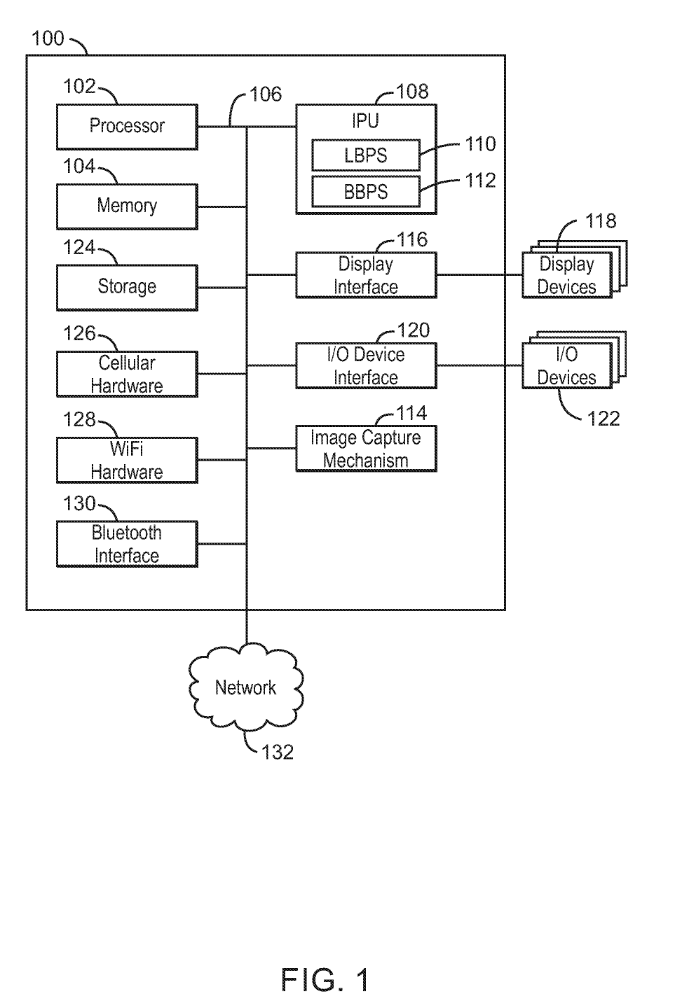

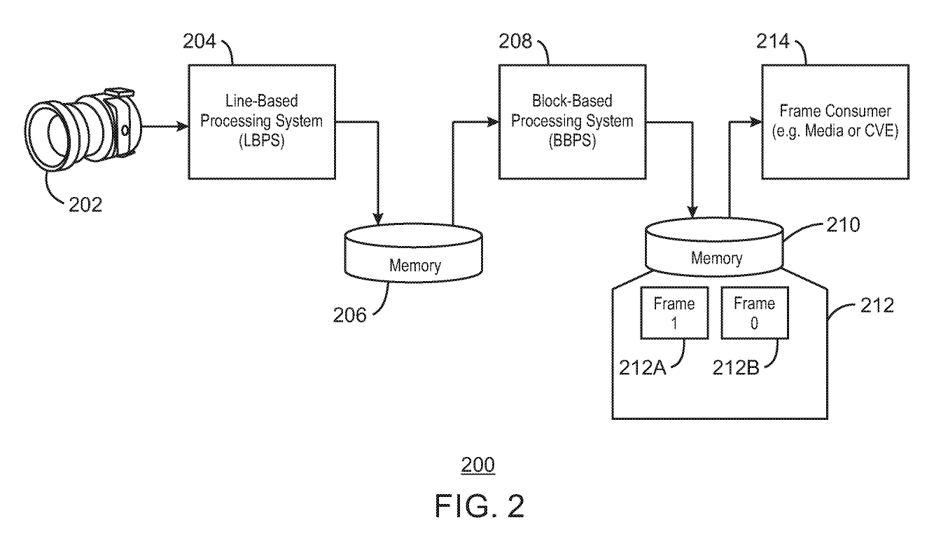

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Often, the computing platforms that include image processing hardware and software are used in applications that capture and render a scene with very little movement from frame to frame. For example, video surveillance applications and video conferencing applications may have very little movement from frame to frame, typically with a distinct dynamic portion and static portion of each frame. In a video surveillance application, the same scene may be captured repeatedly, with very little movement. Similarly, in a video conferencing application, a portion of the video may be static and unchanging (such as the background), and another portion of the display that is dedicated to rendering images of the video conferencing participants may be dynamic and changing.

Regardless of the use case, computing platforms that include an imaging processing unit (IPU) may attempt to keep IPU power consumption as low as possible. By maintaining a low IPU power consumption, thermal output by the IPU can be controlled and minimized. Moreover, in battery powered computing systems, the life of the battery can be extended by keeping IPU power consumption as low as possible.

Embodiments described herein enable tile reuse in imaging. In embodiments, a static or unchanged portion of a tile is not processed by the imaging pipeline. As used herein, a tile refers to a portion or subset of image data. For example, a tile may be a line of imaging data that is stored to memory in a raster order. Additionally, in examples, a tile may be a 16×16 macroblock for processing in block based image processing. In embodiments, a tile may be a portion of image data to be processed during each clock cycle. The present techniques determine the tiles of the captured image that remain static (unchanged) between consecutive frames or between a plurality of frames. By not processing these static (unchanged) tiles, power dissipation of the IPU and memory input/output (I/O) subsystem may be reduced. Thus, in embodiments, processing of static tiles is terminated as soon as possible in the imaging pipeline. A last changed tile may be substituted or reused in place of the static tiles. Tiles that are designated as dynamic or changed tiles are to be processed by imaging pipeline of the IPU.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of a computing device 100 configured for tile reuse during imaging. The computing device 100 may be, for example, a laptop computer, tablet computer, mobile phone, smart phone, or a wearable device, among others. The computing device 100 may also be a system-on-chip (SOC). The computing device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the computing device 100 may include more than one CPU 102. The memory device 104 can include random access memory (RAM), read only memory (ROM), flash memory, or any other suitable memory systems. For example, the memory device 104 may include dynamic random access memory (DRAM).

The computing device 100 also includes an image processing unit (IPU) 108. As shown, the CPU 102 can be coupled through the bus 106 to the IPU 108. The IPU 108 can be configured to perform any number of imaging operations within the computing device 100. For example, the IPU 108 can be configured to render or manipulate images, frames, videos, or the like, to be displayed to a user of the computing device 100. In some embodiments, the IPU 108 includes a number of imaging engines, wherein each imaging engine is configured to perform specific imaging tasks, or to execute specific types of workloads. For example, the IPU 108 may include an engine that processes imaging data for tile reuse.

In embodiments, the IPU may execute a pipeline that comprises each of a line based processing system (LBPS) 110 and a block based processing system (BBPS) 112. In examples, the IPU may obtain image data from an image capture mechanism 114, where the image data is obtained from the image capture device in a line-by-line fashion. In particular, a raw image file may be obtained from the image capture mechanism 114, where the raw file contains full resolution (typically 12- or 14-bit) data as read out from each of the camera's image sensor pixels. An LBPS 110 may process the image data line by line and store the processed data in the memory 104. For subsequent processing, the BBPS 112 may obtain blocks of image data from the memory 104 for further processing. After block based processing, the image data may be again stored in the memory for further use by imaging applications.

The CPU 102 can be linked through the bus 106 to a display interface 116 configured to connect the computing device 100 to one or more display devices 118. The display devices 118 can include a display screen that is a built-in component of the computing device 100. The display devices 118 can also include a computer monitor, television, or projector, among others, that may be externally connected to the computing device 100.

The CPU 102 can also be connected through the bus 106 to an input/output (I/O) device interface 120 configured to connect the computing device 100 to one or more I/O devices 122. The I/O devices 120 can include, for example, a keyboard and a pointing device, wherein the pointing device can include a touchpad or a touchscreen, among others. The I/O devices 122 can be built-in components of the computing device 100, or can be devices that are externally connected to the computing device 100.

The computing device may also include a storage device 124. The storage device 124 is a physical memory such as a hard drive, an optical drive, a flash drive, an array of drives, or any combinations thereof. The storage device 124 can store user data, such as audio files, video files, audio/video files, and picture files, among others. The storage device 124 can also store programming code such as device drivers, software applications, operating systems, and the like. The programming code stored to the storage device 124 may be executed by the CPU 102, IPU 108, or any other processors that may be included in the computing device 100.

The CPU 102 may be linked through the bus 106 to cellular hardware 126. The cellular hardware 126 may be any cellular technology, for example, the 4G standard (International Mobile Telecommunications-Advanced (IMT-Advanced) Standard promulgated by the International Telecommunications Union—Radio communication Sector (ITU-R)). In this manner, the computing device 100 may access any network 132 without being tethered or paired to another device, where the network 132 is a cellular network.

The CPU 102 may also be linked through the bus 106 to WiFi hardware 128. The WiFi hardware is hardware according to WiFi standards (standards promulgated as Institute of Electrical and Electronics Engineers' (IEEE) 802.11 standards). The WiFi hardware 128 enables the computing device 100 to connect to the Internet using the Transmission Control Protocol and the Internet Protocol (TCP/IP), where the network 132 is the Internet. Accordingly, the computing device 100 can enable end-to-end connectivity with the Internet by addressing, routing, transmitting, and receiving data according to the TCP/IP protocol without the use of another device. Additionally, a Bluetooth Interface 130 may be coupled to the CPU 102 through the bus 106. The Bluetooth Interface 130 is an interface according to Bluetooth networks (based on the Bluetooth standard promulgated by the Bluetooth Special Interest Group). The Bluetooth Interface 130 enables the computing device 100 to be paired with other Bluetooth enabled devices through a personal area network (PAN). Accordingly, the network 132 may be a PAN. Examples of Bluetooth enabled devices include a laptop computer, desktop computer, ultrabook, tablet computer, mobile device, or server, among others.

The block diagram of FIG. 1 is not intended to indicate that the computing device 100 is to include all of the components shown in FIG. 1. Rather, the computing system 100 can include fewer or additional components not illustrated in FIG. 1 (e.g., sensors, power management integrated circuits, additional network interfaces, etc.). The computing device 100 may include any number of additional components not shown in FIG. 1, depending on the details of the specific implementation. Furthermore, any of the functionalities of the CPU 102 may be partially, or entirely, implemented in hardware and/or in a processor. For example, the functionality may be implemented with an application specific integrated circuit, in logic implemented in a processor, in logic implemented in a specialized graphics processing unit, or in any other device.

In a number of imaging applications, portions of the images captured by a camera and processed by the IPU often remain static from frame to frame. For example, the video surveillance system mentioned above monitors the interior or exterior of a building for security purposes and often captures the same interior or exterior image repeatedly for extended periods of time with little or no movement (motion) in the captured images. In another example, images captured for the video conferencing application include the figure of a person speaking within a static (non-changing, motionless) background. The present techniques use the static portion of each image to determine which tiles to eliminate within each frame from further processing. This information is used to reduce both the amount of processing that is done in the IPU, as well as the amount of data transferred between the IPU and system memory, which also reduces system-on-chip (SOC) power dissipation. In embodiments, unchanged/static tiles are determined even in the presence of noise in the imaging data. Noise is typically always present in captured images. Even if the camera captures a plurality of frames in a totally static setting, some pixels will change from one frame to the next due to noise. The present techniques reduce IPU processing and input/output (I/O) traffic of otherwise static captured images in the presence of such noise. Accordingly, the present techniques can be applied to raw image data, prior to any de-noising or processing of the raw image data.

FIG. 2 is an image processing (IPU) system 200. Images are captured by a camera 202 and transmitted to a Line Based Processing System (LBPS) 204 which processes a line (or a few lines) of imaging data during each clock cycle. In embodiments, the LBPS 204 processes a tile during each clock cycle. The line-based processing system 204 enables pixel data to be processed in raster-order from the camera 202. After processing in a line-by-line fashion at block 204, the processed lines may be stored in a memory 206.

In embodiments, the imaging data may be in the form of pixels. In some cases, each pixel captured by the camera 202 is represented by several components. For example, in the YUV color space, pixel data is represented by one luma (Y) and two chrominance (UV) components. In an RGB color space, each pixel is represented by a red (R), green (G), and blue (B) component. Various memory schemes can dictate how each pixel component is stored. For example, the YUV color space may be stored according to an NV12 or YV12 scheme.

In embodiments, the image sensor of the camera 202 typically scans pixels in raster order, and scans an entire line before the image sensor moves on to the next line. Thus, the LBPS 204 processes lines of the captured image instead of blocks. Line based processing may include operations such as normalization, linearization, optical black correction, de-noising, and the like. At the output of the LBPS, processed lines are stored in system memory 206. A block based processing system (BBPS) 208 may read blocks of various sizes from the memory 206 to perform further processing. In embodiments, a block may be a block of pixels of any size, such as 70×40 pixels. Block based processing includes but is not limited to operations such as Geometric Distortion Correction (GDC), Temporal Noise Reduction (TNR), output stage processing, and the like. The processed data in block form is stored in a system memory 210 of the pipeline 200. After storage in the system memory 210, the processed data may be partitioned into frames that are available for consumption by a frame consumer at block 214, such as an imaging application. Other frame consumers include a media engine or a computer vision engine.

In some cases, the frames may be stored in a buffer 212. Depending on the buffering scheme, the buffer 212 may comprise a plurality of buffers, such as a buffer 212A and a buffer 212B. In embodiments, applications that consume the frame data obtain the frame data from the plurality of buffers. For example, when the IPU is currently filling frame buffer 212A with new pixels, the previously produced frame buffer 212B is consumed by the consumer at block 214. In a double buffering scheme, buffers 212A and 212B are periodically flipped, so that after the IPU has completed producing frame 1 from buffer 212A, the IPU starts filling buffer 212B with new pixels, while the consumer consumes buffer 212A. When the IPU completes filling up buffer 212B, then it delivers it to the consumer 214, and then starts writing the next frame back into buffer 212A, etc. The present techniques can be used with double buffering, triple buffering, quad buffering, and the like.

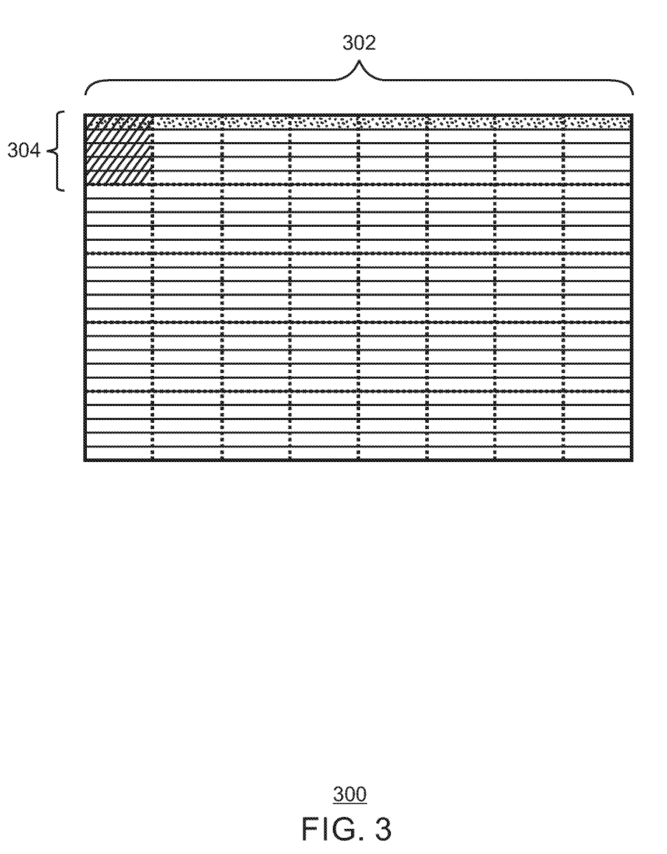

FIG. 3 is an illustration of a memory 300. In FIG. 3, the memory partitions show a number of tiles with varying sizes. In particular, a frame can be partitioned into tiles of various sizes, including both lines and blocks. As used herein, both lines and blocks are tiles of different sizes. For example, a line of a 1920×1080 frame may be a tile with dimensions of 1920×1 pixels, whereas a block of a frame may be a tile with dimensions of 16×16 pixels. FIG. 3 illustrates a line 302 with dots throughout the line. As mentioned earlier the LBPS 204 (FIG. 2) processes one or more lines at a time, whereas the BBPS 208 (FIG. 2) processes blocks. FIG. 3 illustrates a block 304 with cross-hatching.

The present techniques identify tiles (lines or blocks) in a captured frame which have not changed relative to the previously captured frame. If a tile can be flagged as ‘non-changing’, then the LBPS or the BBPS may be able to skip processing of that tile, since it has already processed information covered by that tile before. In embodiments, the flag enables the unchanged tiles to be tracked in the imaging processing pipeline. Thus, the last processed unchanged tile is reused until a change in the particular tile is detected. In this manner, repetitive processing of a scene or portions of a scene that has not changed is eliminated. In embodiments, if tile of a new frame N has not changed relative to the same tile at frame N−2 (i.e. two frames back), then the IPU can avoid writing that unchanged tile back to the frame buffer (frame buffer 212A or 212B of FIG. 2) which it is currently filling with additional imaging data a double buffering scheme. The frame does not need to be written to the frame buffer since the tile has already been produced in that frame buffer two frames back and it is already available in the particular frame buffer. Thus, frame N−2 is repeated or reused when necessary, without transmission of the same unchanged data.

In embodiments, a tile is designated as an unchanged tile as early as possible in an image processing pipeline. In embodiments, the tile is designated as unchanged prior to any processing of the raw image data. The earlier the unchanged tile designation is applied, the greater processing that is skipped along the pipeline in the case of non-changing tiles. Further, the early indication of an unchanged tile results in less power consumption and less power dissipation during processing because fewer tiles are processed. In embodiments, various practical considerations may apply the search for unchanged tiles later in the processing pipeline. For example, an implementation may opt to first de-noise the frame lines captured by the sensor and fed into the LBPS before detecting whether the lines have changed relative to previous frame. In this example, only a portion of the LBPS processing and power dissipation (and all of the BBPS power dissipation) would be saved when static (non-changing) lines are captured. In some implementations, the present techniques may be employed at the BBPS at the back end of the IPU pipeline and not in the LBPS front end.

The definition of a changed tile may vary according to the particular implementation. As a first definition, in the strictest sense a tile has “not changed” if the pixel values of all pixels in the tile are exactly the same in the current frame N as in the frame used for comparison, such as frame N−2. In embodiments, the pixel values are any value within a color space applied to individual pixels, such as RGB values or YUV values. This first definition of an unchanged pixel may give false readings as far as changed tiles, as noise may be always present in an imaging system. The noise results in pixels that will always change, even if the image being captured contains no-motion at all. The noise and other relatively small changes in pixel values of a few pixels in a tile typically go unnoticed when the image is viewed.

For example, assume a 1920×1 tile (line) in which each pixel consists of three 8-bit RGB values that range from 0 to 255. If, for example, 20 to 30 pixels in this line have their values changed by 5 or less, then this change of pixel values in the tile is hardly noticeable to a user. Thus, if a particular pixel value changes from R=100 to R=95 or R=105, this change in pixel value is usually undetectable by the human eye. Hence, a second definition of an unchanged tile is a tile that has a percentage of pixels of the tile within a range or threshold (T2) where the pixel value change of those pixels are within a first range or threshold (T1). The thresholds may be used in comparisons of a current tile in a current frame to a same tile in another frame, wherein the same tile is a tile that has the same location or coordinates as the current tile.

In another example, assume a 1920×1 tile size, and threshold values of T1=5 pixel values and T2=2%. If less than 2% of the 1920 pixels in the 1920×1 tile have their R, G, and B values change by less than 5 pixel values between two frames selected for comparison (where the frames selected for comparison is dependent on the buffering scheme), then this tile may be a non-changing, static tile. In the case where less than 2% of the 1920 pixels in the 1920×1 tile have their R, G, and B values change by more than 5 pixel values between two frames selected for comparison, the tile may still be considered a non-changing, static tile as the number of pixels that have experienced a relatively large change is low. In the case where more than 2% of the 1920 pixels in the 1920×1 tile have their R, G, and B values change by less than 5 pixel values between two frames selected for comparison, the tile may be considered a non-changing, static tile since the pixel value change that has occurred is minimal, even though the number of pixels that changed in relatively large. Table 1 further describes the relationship between the thresholds T1/T2 and the resulting tile designation.

| | Threshold T2 | |
|---|---|---|
| Threshold T1 | Percentage/Number | |
| Pixel value | Pixels | Tile Designation |
| Greater than T1 | Greater than T2 | Changed Tile |
| Greater than T1 | Less than T2 | Unchanged Tile |
| Less than T1 | Greater than T2 | Unchanged Tile |
| Less than T1 | Less than T2 | Unchanged Tile |

Thus, as illustrated by Table 1, a first number of changed pixels of a current tile that has changed pixel values may be determined. The first number of changed pixels may determine how many tiles have pixel vales that have changed when compared to a previous tile. Then, a percentage of the current tile that has those changed values above a first threshold may be determined. In embodiments, this represents the percentage of the tile that has a change that is noticeable to the human eye. The tile may be flagged as changed in response to this percentage being greater than a second threshold. The second threshold may be the number of pixels wherein a change in those pixels is detectable by the human eye.

In embodiments, the change in pixels may be used to generate a signature for each tile. The signatures of tiles may be compared to determine if a tile has changed. In particular, a signature may be generated by using the pixel values in a checksum or hash function. In embodiments, only changed pixels are used in the checksum or hash function.

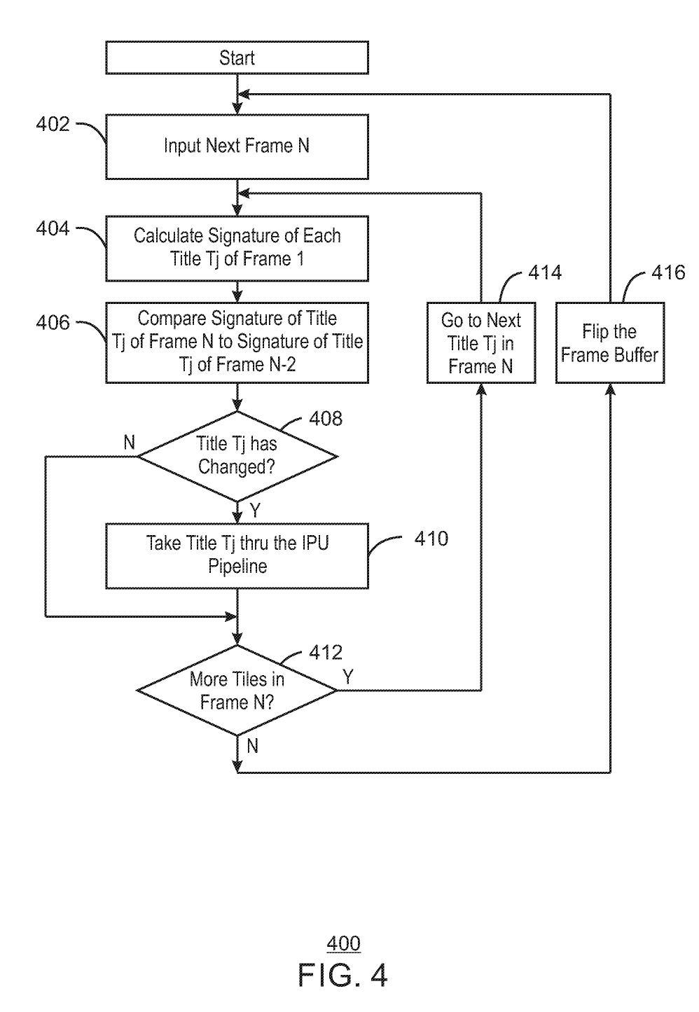

FIG. 4 is a process flow diagram of a method 400 for tile reuse. Each new frame N is input at block 402. For each new frame N that appears at the input of IPU, all tiles (lines or blocks) in the frame may be scanned. At block 404, a signature is generated for each tile Tj of a frame 1. In embodiments, the signature is generated using raw lines of data from the camera or image sensor that are fed to the LBPS, before any processing has been done to the tiles. In some cases, the signature is generated after minimal processing has been applied to the tiles, such as a de-noise function.

In embodiments, the signature is a mathematical function that represents the amount of change that has occurred in the pixels of a tile from a frame N−2 to a frame N. General properties of the signature are that first, the signature of a ‘large’ tile, e.g. of a 1920×1 line, is only a few bytes long. Second, small or large changes in the R, G, B (or Y, U, V) values of the tile pixels result in small or large changes, respectively, in the signature value, which means that small or large changes in signature values can be assumed to represent small or large change in the tile. In examples, a signature function may be a function that combines an average and a standard deviation of the pixel values in each tile. There may be separate signatures for each of the R, G and B—or for the Y, U and V—pixel values. The quality of a signature function may be determined both by its size and responsiveness. The size of the function refers to the feature that signature values are small enough so they can be easily stored on local IPU caches, to avoid fetching signature values from system memory. The responsiveness of the function refers to how safely small or large changes in signature values can actually map to small or large changes, respectively, to RGB (or YUV) values in a tile.

At block 406, once the signature of a tile has been calculated, it will be compared against the signature of the same tile two frames back. In examples, assume that there are two frame buffers B1 and B2 in system memory and processed frame data is flipped between the two buffers. While the IPU captures and processes frame N and stores it in buffer B2 in memory, some other engine (e.g. video or display) processes frame N−1 which the IPU previously captured stored in buffer B1. Now when the IPU moves on to capture the next frame N+1, it will store frame N+1 in buffer B1 (this is known as buffer flipping), while at the same time the video or display engine consumes frame N stored in buffer B2. The IPU will compare tiles of the new frame N+1 to the same tiles in frame N−1 (i.e. two frames back) which are already stored in buffer B1. If the tiles have not changed, the IPU will not need to copy them into frame B1 (coping data in to a buffer in memory costs power), but rather it will reuse those tiles which already exist in buffer B1 in system memory. In the double buffering scheme, the IPU cannot work with frame N+1 and N (i.e. one frame back) because frame N is in the process of getting consumed by the video or display engine and the IPU is not supposed to touch it or interfere with it during that time.

At block 408, it is determined if the tile Tj has changed based on the comparison of the signature. If the signature indicates a change less than a predetermined delta, then the tile is flagged as not changed, the IPU does not further process this tile and the tile is not written back to memory (since it is already available in the flip buffer in system memory) and processing continues of block 412. The termination of processing may occur at various locations within the processing pipeline, such as at the LBPS of BBPS. If the tile has changed at block 408 based on the change being greater than a predetermined delta, process flow continues to block 410. At block 410, the tile is processed by the IPU (and stored in system memory).

While blocks 404-410 have been described using the signature to determine a change/unchanged tile, the thresholds T1/T2 may also be used to determine if each tile is a changed/unchanged tile. At block 404, the number or percentage of changed pixels may be determined, along with the amount by which these pixels have changed. At block 406, the thresholds may be compared to the percentage of changed pixels and the number by which each pixel of the changed pixels have changed. At block 408, it can be determined if the tile Tj has changed based on the comparison to thresholds T1/T2 as described at Table 1. If the tile has not changed based on the thresholds, process flow continues to block 412. If the tile has changed based on the thresholds, process flow continues to block 410.

At block 412, it is determined if there are more tiles in frame N. If there are more tiles in frame N, process flow continues to block 414. If there are no more tiles in frame N, process flow continues to block 416. At block 414, the next tile Tj in frame N is read and process flow returns to block 404. At block 416, the output frame buffer is flipped, and process flow returns to block 402 where the next frame N is input at the LBPS or BBPS. In other words, while the GPU or the IPU produces a new frame N in buffer B2 in system memory, another client (e.g. display or video engine) may be consuming frame N−1 which the GPU or IPU previously produced and stored in a buffer B1 in system memory. At the end of frame N, the GPU or IPU flips buffers B1 and B2 and then it starts producing a new frame N+1 and storing it in buffer B1, while the video/display engine consumes frame N stored in buffer B2. On the next frame, the operating system flips buffers B1 and B2 again. In embodiments, more than two buffers (B1, B2, B3, etc.) may be used as well to stored rendered or captured frames.

In embodiments, lines of each raw frame N (as they are captured at the sensor and they are passed to the IPU front end) may be stored into system memory. When frame N+2 is later captured, raw lines of frame N are fetched from memory and compared pixel by pixel against the raw lines of the current frame N, to see if the pixels have changed. If the pixels have changed, they are transmitted through the IPU pipeline and processed normally. Otherwise, the raw lines do not need to be processed by the pipeline, since they have been processed previously (in frame N), and they are already available in processed form in system memory and can be reused from there. Functionally this scheme would work as well as the flow of FIG. 4, however, fetching tiles from frame N+2 from memory into the IPU to perform tile comparison may create additional input/output (I/O) traffic which would reduce the overall power reduction that is possible according to the present techniques. In embodiments, the I/O traffic can be mitigated by storing down-sampled lower-resolution raw frames instead of storing full-resolution raw frames in memory. In embodiments, down sampling is essentially a sub-case of calculating a signature function.

In embodiments, down-sampled raw tiles of frames N and N+2 are compared to detect motion between the tiles. If the comparison of these down-sampled raw tiles indicate motion (changing tiles), then the original full-resolution copy of the tiles is transmitted through the IPU pipeline and are processed normally. Otherwise, the full-resolution tiles would not be transmitted for processing through the IPU pipeline since they have been processed previously (in previous frame N) and they are already available in processed form in system memory. Comparing down-sampled instead of full-resolution tiles allows the detection of motion between tiles (i.e. identify changing tiles) while avoiding the power cost of moving high I/O bandwidth to and from memory. In embodiments, the down sampling results in averaging, for example, eight pixels into a single pixel. Note that down-sampling tiles of a frame is essentially a sub-case of computing a signature function on the tiles of the frame, so as to check whether the times have changed or not relative to previous frame, as previously described. Down-sampling pixels of a tile usually involves calculating some sort of average value of neighboring pixels within a tile, hence down-sampling is essentially a (simple) sub-case of computing a signature function across the pixels of a tile.

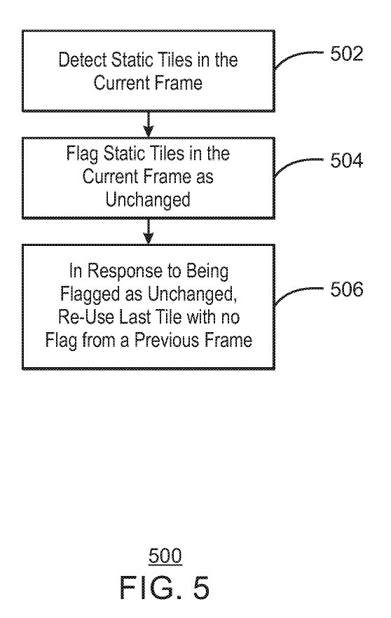

FIG. 5 is a process flow diagram of a method 500 for tile reuse in imaging. At block 502, an image capture mechanism is to capture imaging data. The imaging data may be stored in a memory. In embodiments, the memory is a multi-bank memory. At block 504, unchanging, static tiles are flagged as unchanged. The unchanged tiles may be determined through the use of thresholds T1/T2, a signature, or any combination thereof. At block 506, in response to being flagged as unchanged, the last tile with no changes is reused by consumers. In embodiments, a placeholder is used in place of the unchanged frames. The placeholder may point to the frame that is used in the comparison to determine an unchanged frame. When a consumer requests image data, the pointer may be used to indicate the data to be reuse to reduce the amount of data to be transmitted to the consumer. Consumers include, but are not limited to, video applications, media, or CVE. In this manner, changed frames are processed by the LBPS and BBPS without processing the unchanged frames.

The process flow diagrams of FIGS. 4 and 5 are not intended to indicate that the blocks of methods 400 and 500 are to be executed in any particular order, or that all of the blocks are to be included in every case. Further, any number of additional blocks may be included within the methods 400 and 500, depending on the details of the specific implementation. Additionally, while the methods described herein include an IPU, the memory may be shared between any I/O device such as another CPU or a direct memory access (DMA) controller. Moreover, while the present techniques have been described using an IPU, other processing units may be used, such as a GPU.

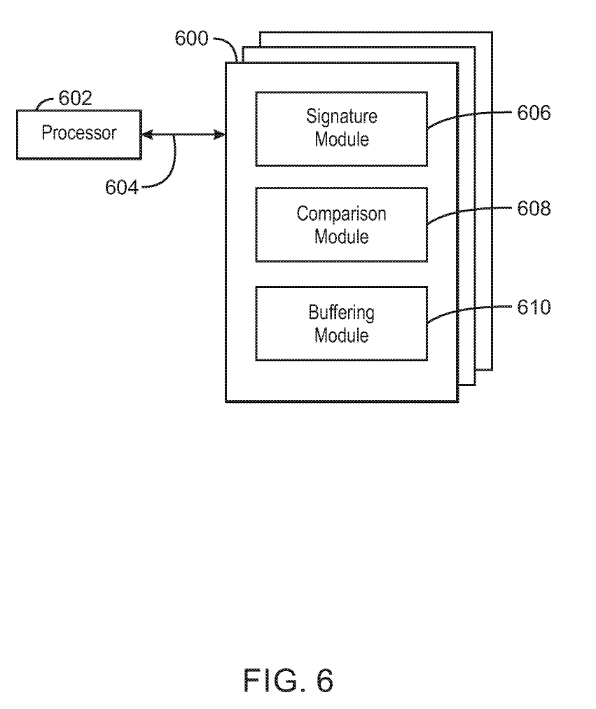

FIG. 6 is a block diagram showing tangible, non-transitory computer-readable media 600 that stores code for tile reuse in imaging. The tangible, non-transitory computer-readable media 600 may be accessed by a processor 602 over a computer bus 604. Furthermore, the tangible, non-transitory computer-readable media 600 may include code configured to direct the processor 602 to perform the methods described herein.

The various software components discussed herein may be stored on the tangible, non-transitory computer-readable media 600, as indicated in FIG. 6. For example, a signature module 606 may be configured to determine signatures of the tiles. A comparison module 608 may be configured to compare the signatures of the tiles to determine which tiles are unchanged tiles. The comparison module 608 may also use predetermined thresholds T1/T2 to determine which tiles are unchanged tiles. A buffering module may be used to store changed tiles that have been processed along with placeholders or pointers for tiles that have not changed.

The block diagram of FIG. 6 is not intended to indicate that the tangible, non-transitory computer-readable media 600 is to include all of the components shown in FIG. 6. Further, the tangible, non-transitory computer-readable media 600 may include any number of additional components not shown in FIG. 6, depending on the details of the specific implementation.

Example 1 is an apparatus for tile reuse in imaging. The apparatus includes a memory to store imaging data; a line-based processing system that is to process lines of imaging data and store the processed data in memory; a block-based processing system that is to process blocks of the line based processed imaging data and storing the processed data in memory; and a tile reuse indicator that is to determine an unchanged tile of the imaging data, and in response to an unchanged tile prevent further processing of the unchanged tile.

Example 2 includes the apparatus of example 1, including or excluding optional features. In this example, a processor is to store a placeholder in memory to replace the unchanged tile.

Example 3 includes the apparatus of any one of examples 1 to 2, including or excluding optional features. In this example, the tile reuse indicator is to determine the unchanged tile of the imaging data via a plurality of thresholds.

Example 4 includes the apparatus of any one of examples 1 to 3, including or excluding optional features. In this example, the tile reuse indicator is to determine the unchanged tile of the imaging data via a signature. Optionally, the signature is determined via a checksum.

Example 5 includes the apparatus of any one of examples 1 to 4, including or excluding optional features. In this example, the tile reuse indicator is to determine the unchanged tile of the imaging data via down sampled imaging data.

Example 6 includes the apparatus of any one of examples 1 to 5, including or excluding optional features. In this example, the tile reuse indicator is to determine an unchanged tile of the imaging data during processing by the line based processing system.

Example 7 includes the apparatus of any one of examples 1 to 6, including or excluding optional features. In this example, the tile reuse indicator is to determine an unchanged tile of the imaging data during processing by the block based processing system.

Example 8 includes the apparatus of any one of examples 1 to 7, including or excluding optional features. In this example, in response to an unchanged tile the tile reuse indicator prevents further transmission of the unchanged tile in an imaging processing pipeline.

Example 9 includes the apparatus of any one of examples 1 to 8, including or excluding optional features. In this example, a flag is set by the tile reuse indicator to indicate an unchanged tile.

Example 10 is a system for tile reuse in imaging. The system includes a memory; a camera; and a processor coupled to the memory and the camera, the processor to: capture imaging data via the camera; determine a signature for a current frame of the imaging data; compare the signature for a tile of the current frame of the imaging data to a signature of a same tile of a previous frame; prevent further processing of the tile of the current frame of imaging data in response to the signature of the tile of the current frame being substantially equivalent to the signature of the same tile of the previous frame; and store a placeholder in memory in place of the tile of the current frame of imaging data.

Example 11 includes the system of example 10, including or excluding optional features. In this example, the signature is generated by a checksum.

Example 12 includes the system of any one of examples 10 to 11, including or excluding optional features. In this example, the signature is a mathematical function that indicates an amount of change between the tile of the current frame and the same tile of the previous frame.

Example 13 includes the system of any one of examples 10 to 12, including or excluding optional features. In this example, the signature is a function that combines an average and a standard deviation of the pixel values in each tile.

Example 14 includes the system of any one of examples 10 to 13, including or excluding optional features. In this example, the signature of each tile is stored in an IPU cache.

Example 15 includes the system of any one of examples 10 to 14, including or excluding optional features. In this example, the signature is generated via down sampled imaging data.

Example 16 includes the system of any one of examples 10 to 15, including or excluding optional features. In this example, a value of the signature maps to a change in pixel value of the imaging data.

Example 17 includes the system of any one of examples 10 to 16, including or excluding optional features. In this example, the signature is calculated by a line based processing system.

Example 18 includes the system of any one of examples 10 to 17, including or excluding optional features. In this example, the signature is calculated by a block based processing system.

Example 19 includes the system of any one of examples 10 to 18, including or excluding optional features. In this example, the placeholder is a pointer to a last unchanged tile.

Example 20 is a system for tile reuse in imaging. The system includes a memory; a camera; and a processor coupled to the memory and the camera, the processor to: capture imaging data via the camera; determine a first number of changed pixels of a current tile that have changed pixel values; determine a percentage of the current tile that has the changed pixel values above a first threshold; flag the current tile as changed in response to the percentage being greater than a second threshold for a current frame of the imaging data; prevent further processing of the current tile of the current frame in response to the current tile being flagged as unchanged; and store a placeholder in memory in place of the current tile of the current frame of imaging data.

Example 21 includes the system of example 20, including or excluding optional features. In this example, the placeholder is a pointer to a last unchanged tile.

Example 22 includes the system of any one of examples 20 to 21, including or excluding optional features. In this example, the first threshold and the second threshold are predetermined.

Example 23 includes the system of any one of examples 20 to 22, including or excluding optional features. In this example, a processor is to store a placeholder in memory to replace the unchanged tile.

Example 24 includes the system of any one of examples 20 to 23, including or excluding optional features. In this example, the first number of changed pixels and the percentage of the current tile that has the changed pixel values above a first threshold is determined via down sampled imaging data.

Example 25 includes the system of any one of examples 20 to 24, including or excluding optional features. In this example, the first number of changed pixels and the percentage of the current tile that has the changed pixel values above a first threshold is determined via raw line based imaging data without any processing.

Example 26 includes the system of any one of examples 20 to 25, including or excluding optional features. In this example, the first number of changed pixels and the percentage of the current tile that has the changed pixel values above a first threshold is determined via a block based processing system.

Example 27 includes the system of any one of examples 20 to 26, including or excluding optional features. In this example, the first number of changed pixels and the percentage of the current tile that has the changed pixel values above a first threshold is determined via a line based processing system.

Example 28 includes the system of any one of examples 20 to 27, including or excluding optional features. In this example, in response to the tile being flagged as changed, preventing any further transmission of the unchanged tile in an imaging processing pipeline.

Example 29 is a method for tile reuse in imaging. The method includes capturing imaging data; processing lines of imaging data via a line-based processing system and storing the processed lines of imaging data in memory; processing blocks of the processed lines of imaging data in memory via a block based processing system and storing the processed blocks of data in memory; and determining an unchanged tile of the imaging data, and in response to an unchanged tile preventing further processing of the unchanged tile.

Example 30 includes the method of example 29, including or excluding optional features. In this example, the method includes storing a placeholder in memory to replace the unchanged tile.

Example 31 includes the method of any one of examples 29 to 30, including or excluding optional features. In this example, the method includes determining the unchanged tile of the imaging data via a plurality of thresholds.

Example 32 includes the method of any one of examples 29 to 31, including or excluding optional features. In this example, the method includes determining the unchanged tile of the imaging data via a signature. Optionally, the signature is determined via a checksum.

Example 33 includes the method of any one of examples 29 to 32, including or excluding optional features. In this example, the method includes determining the unchanged tile of the imaging data via down sampled imaging data.

Example 34 includes the method of any one of examples 29 to 33, including or excluding optional features. In this example, the method includes determining the unchanged tile of the imaging data during processing by the line based processing system.

Example 35 includes the method of any one of examples 29 to 34, including or excluding optional features. In this example, the method includes determining the unchanged tile of the imaging data during processing by the block based processing system.

Example 36 includes the method of any one of examples 29 to 35, including or excluding optional features. In this example, the method includes preventing the further transmission of the unchanged tile in an imaging processing pipeline in response to the unchanged tile.

Example 37 includes the method of any one of examples 29 to 36, including or excluding optional features. In this example, the method includes setting a tile reuse indicator to indicate an unchanged tile in an imaging processing pipeline.

Example 38 is a tangible, non-transitory, computer-readable medium. The computer-readable medium includes instructions that direct the processor to capture imaging data; process lines of imaging data via a line-based processing system and storing the processed lines of imaging data in memory; process blocks of the processed lines of imaging data in memory via a block based imaging system and storing the processed blocks of data in memory; and determine an unchanged tile of the imaging data, and in response to an unchanged tile prevent further processing of the unchanged tile.

Example 39 includes the computer-readable medium of example 38, including or excluding optional features. In this example, the computer-readable medium includes storing a placeholder in memory to replace the unchanged tile.

Example 40 includes the computer-readable medium of any one of examples 38 to 40, including or excluding optional features. In this example, the computer-readable medium includes determining the unchanged tile of the imaging data via a plurality of thresholds.

Example 41 includes the computer-readable medium of any one of examples 38 to 40, including or excluding optional features. In this example, the computer-readable medium includes determining the unchanged tile of the imaging data via a signature. Optionally, the signature is determined via a checksum.

Example 42 includes the computer-readable medium of any one of examples 38 to 41, including or excluding optional features. In this example, the computer-readable medium includes determining the unchanged tile of the imaging data via down sampled imaging data.

Example 43 includes the computer-readable medium of any one of examples 38 to 42, including or excluding optional features. In this example, the computer-readable medium includes determining the unchanged tile of the imaging data during processing by the line based processing system.

Example 44 includes the computer-readable medium of any one of examples 38 to 43, including or excluding optional features. In this example, the computer-readable medium includes determining the unchanged tile of the imaging data during processing by the block based processing system.

Example 45 includes the computer-readable medium of any one of examples 38 to 44, including or excluding optional features. In this example, the computer-readable medium includes preventing the further transmission of the unchanged tile in an imaging processing pipeline in response to the unchanged tile.

Example 46 includes the computer-readable medium of any one of examples 38 to 45, including or excluding optional features. In this example, the computer-readable medium includes setting a tile reuse indicator to indicate an unchanged tile in an imaging processing pipeline.

Example 47 is an apparatus for tile reuse in imaging. The apparatus includes instructions that direct the processor to a memory to store imaging data; a line-based processing system that is to process lines of imaging data and store the processed data in memory; a block-based processing system that is to process blocks of the line based processed imaging data and storing the processed data in memory; and a means to determine an unchanged tile of the imaging data, and in response to an unchanged tile prevent further processing of the unchanged tile.

Example 48 includes the apparatus of example 47, including or excluding optional features. In this example, a processor is to store a placeholder in memory to replace the unchanged tile.

Example 49 includes the apparatus of any one of examples 47 to 48, including or excluding optional features. In this example, the means to determine the unchanged tile is to determine the unchanged tile of the imaging data via a plurality of thresholds.

Example 50 includes the apparatus of any one of examples 47 to 49, including or excluding optional features. In this example, the means to determine the unchanged tile is to determine the unchanged tile of the imaging data via a signature. Optionally, the signature is determined via a checksum.

Example 51 includes the apparatus of any one of examples 47 to 50, including or excluding optional features. In this example, the means to determine the unchanged tile is to determine the unchanged tile of the imaging data via down sampled imaging data.

Example 52 includes the apparatus of any one of examples 47 to 51, including or excluding optional features. In this example, the means to determine the unchanged tile is to determine an unchanged tile of the imaging data during processing by the line based processing system.

Example 53 includes the apparatus of any one of examples 47 to 52, including or excluding optional features. In this example, the means to determine the unchanged tile is to determine an unchanged tile of the imaging data during processing by the block based processing system.

Example 54 includes the apparatus of any one of examples 47 to 53, including or excluding optional features. In this example, in response to an unchanged tile the means to determine the unchanged tile prevents further transmission of the unchanged tile in an imaging processing pipeline.

Example 55 includes the apparatus of any one of examples 47 to 54, including or excluding optional features. In this example, a flag is set by the means to determine the unchanged tile to track the unchanged tile.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. An apparatus for tile reuse in imaging, comprising:
a memory to store imaging data;
a line-based processing system that is to process lines of imaging data and store the processed data in memory;
a block-based processing system that is to process blocks of the line based processed imaging data and to store the processed data in memory; and
a tile reuse indicator that is to determine an unchanged tile of the imaging data, and in response to an unchanged tile prevent further processing of the unchanged tile.

2. The apparatus of claim 1, wherein a processor is to store a placeholder in memory to replace the unchanged tile.

3. The apparatus of claim 1, wherein the tile reuse indicator is to determine the unchanged tile of the imaging data via a plurality of thresholds.

4. The apparatus of claim 1, wherein the tile reuse indicator is to determine the unchanged tile of the imaging data via a signature, and the signature is determined via a checksum.

5. The apparatus of claim 1, wherein the tile reuse indicator is to determine the unchanged tile of the imaging data via down sampled imaging data.

6. The apparatus of claim 1, wherein the tile reuse indicator is to determine an unchanged tile of the imaging data during processing by the line based processing system.

7. The apparatus of claim 1, wherein the tile reuse indicator is to determine an unchanged tile of the imaging data during processing by the block based processing system.

8. The apparatus of claim 1, wherein in response to an unchanged tile the tile reuse indicator prevents further transmission of the unchanged tile in an imaging processing pipeline.

9. The apparatus of claim 1, wherein a flag is set by the tile reuse indicator to indicate an unchanged tile.

10. A system for tile reuse in imaging, comprising:
a memory;
a camera; and
a processor coupled to the memory and the camera, the processor to:
capture imaging data via the camera;
determine a signature for a current frame of the imaging data;
compare the signature for a tile of the current frame of the imaging data to a signature of a same tile of a previous frame;
prevent further processing of the tile of the current frame of imaging data in response to the signature of the tile of the current frame being substantially equivalent to the signature of the same tile of the previous frame; and
store a placeholder in memory in place of the tile of the current frame of imaging data.

11. The system of claim 10, wherein the signature is generated by a checksum.

12. The system of claim 10, wherein the signature is a mathematical function that indicates an amount of change between the tile of the current frame and the same tile of the previous frame.

13. The system of claim 10, wherein the signature is a function that combines an average and a standard deviation of the pixel values in each tile.

14. The system of claim 10, wherein the signature of each tile is stored in an IPU cache.

15. A system for tile reuse in imaging, comprising:
a memory;
a camera; and
a processor coupled to the memory and the camera, the processor to:
capture imaging data via the camera;
determine a first number of changed pixels of a current tile that have changed pixel values;
determine a percentage of the current tile that has the changed pixel values above a first threshold;
flag the current tile as changed in response to the percentage being greater than a second threshold for a current frame of the imaging data;
prevent further processing of the current tile of the current frame in response to the current tile being flagged as unchanged; and
store a placeholder in memory in place of the current tile of the current frame of imaging data.

16. The system of claim 15, wherein the placeholder is a pointer to a last unchanged tile.

17. The system of claim 15, wherein the first threshold and the second threshold are predetermined.

18. The system of claim 15, wherein a processor is to store a placeholder in memory to replace the unchanged tile.

19. The system of claim 15, wherein the first number of changed pixels and the percentage of the current tile that has the changed pixel values above a first threshold is determined via down sampled imaging data.

20. The system of claim 15, wherein the first number of changed pixels and the percentage of the current tile that has the changed pixel values above a first threshold is determined via raw line based imaging data without any processing.

21. The system of claim 15, wherein the first number of changed pixels and the percentage of the current tile that has the changed pixel values above a first threshold is determined via a block based processing system.

22. A method for tile reuse in imaging, comprising:
capturing imaging data;
processing lines of imaging data via a line-based processing system and storing the processed lines of imaging data in memory;
processing blocks of the processed lines of imaging data in memory via a block based processing system and storing the processed blocks of data in memory; and
determining an unchanged tile of the imaging data, and in response to an unchanged tile preventing further processing of the unchanged tile.

23. The method of claim 22, comprising storing a placeholder in memory to replace the unchanged tile.

24. The method of claim 22, comprising determining the unchanged tile of the imaging data via a plurality of thresholds.

25. The method of claim 22, comprising determining the unchanged tile of the imaging data via a signature.
